(19) United States
(12) Patent Application Publication
(10) Pub. No.: US 2024/0242041 A1
(43) Pub. Date: Jul. 18, 2024

(54) SMART ENCLOSURE WITH ELECTROMAGNETIC SIGNAL SHIELDING

(71) Applicant: Green Lambda Corporation, Norman, OK (US)

(72) Inventors: Mohammad H. Raza, Norman, OK (US); Ahmed Arsalan, Norman, OK (US); Jose Pats, Norman, OK (US); Sang A. Cooc, Norman, OK (US); Phuc Ly, Norman, OK (US); Robert O’Neil, Norman, OK (US)

(21) Appl. No.: 18/412,367

(22) Filed: Jan. 12, 2024

Related U.S. Application Data
(60) Provisional application No. 63/438,781, filed on Jan. 12, 2023.

(51) Int. Cl. G06K 7/10; B65D 43/16; B65D 53/02

(52) U.S. Cl. CPC G06K 7/10297; B65D 43/163; B65D 53/02

(57) ABSTRACT

A smart enclosure for storing objects is provided. The smart enclosure has a body with an open interior and a blocking member. The blocking member may be a door, cover or lid. The blocking member is secured to the body and is movable relative to the body between an open position and a closed position. The body and blocking member are made to limit electromagnetic signals outside the enclosure from entering the enclosure and electromagnetic signals inside the enclosure from exiting the enclosure. One or more shielding members may be secured to the body and/or the blocking member so that when the blocking member is in the closed position, the shielding of electromagnetic signals outside the enclosure from entering the enclosure and electromagnetic signals inside the enclosure from exiting the enclosure can be improved. The blocking member or body of the enclosure may include a controller adapted to read RFID or NFC tags, store tag information read from the RFID or NFC tags within the enclosure and to transmit the stored tag information to one or more devices external to the enclosure.

### RELATED APPLICATIONS

This application claims priority to co-pending U.S. Provisional Application No. 63/438,781, filed on Jan. 12, 2023 and entitled “Smart Enclosure with EMI/RFI Shielding” which is incorporated herein in its entirety by reference.

### TECHNICAL FIELD

The present disclosure relates to enclosures, and more particularly to smart enclosures with electromagnetic signal shielding.

### DESCRIPTION OF THE RELATED ART

In large datacenters, supplies for the equipment in the datacenter may be stored in one or more storage boxes. For example, 3 foot fiber optic cables may be stored in one storage box and 25 foot fiber optic cables may be stored in another storage box, etc. As another example, various size fiber optic cables may be stored in the same storage box. However, no one may actually know how many fiber optic cables are in particular storage boxes and what type and/or length of fiber optic cables are in such storage boxes.

The present disclosure provides embodiments of smart enclosures with an RFID reader to read RFID tags on the equipment stored in the enclosure. To limit the RFID reader from receiving electromagnetic signals from RFID tags in storage enclosures within range of the RFID reader, the enclosures according to the present disclosure are shielded to prevent the electromagnetic signals from RFID tags outside the enclosure from being read by the reader inside the enclosure and vice versa.

### SUMMARY

The present disclosure provides embodiments or smart enclosures configured and/or adapted to maintain an inventory of objects stored in the enclosure and to shield an open interior or the enclosure so that electromagnetic signals, e.g., RFID or NFC signals, electromagnetic interference (EMI) or radio-frequency interference (RFI), do not enter the enclosure, and so that electromagnetic signals, e.g., RFID or NFC signals, within the enclosure do not exit the enclosure. According to an exemplary embodiment, the smart enclosure according to the present disclosure includes an enclosure body having an open interior and at least one blocking member (e.g., a door, cover or lid) movably secured to the enclosure body. For example, if the enclosure is shaped as a cube or rectangular prism and the at least one blocking member is a cover, the enclosure body may be formed by one or more side walls and a bottom wall, and the blocking member may be a cover on the top of the enclosure body. If the enclosure is shaped as a cylinder, the enclosure body may be formed by one side wall and a bottom wall, and the blocking member may be a cover on the top of the enclosure body. As another example, if the enclosure is shaped as a cube or rectangular prism and the at least one blocking member is a door, the enclosure body may be formed by one or more side walls, a top wall and a bottom wall, and the blocking member may be a door in one the side walls of the enclosure body. The enclosure body and at least one blocking member are constructed to shield electromagnetic signals from entering the open interior of the enclosure body and to shield electromagnetic signals from exiting the open interior of the enclosure body. The electromagnetic signal shielding of the enclosure may be in the form of a Faraday cage.

The enclosure body has an open interior capable of storing one or more objects that have an RFID or NFC tag attached directly to each object or attached to the packaging holding one or more objects. For enclosures to be placed in datacenters, the objects contemplated by the present disclosure include any equipment or tools that may be stored in the datacenter. Non-limiting examples of the objects that may be stored in the datacenter include fiber optic cables, fiber optic connectors, fiber optic adapters, tie wraps, power cords, modems, routers, etc.

The at least one blocking member is movable relative to the enclosure body between an open position where the open interior of the enclosure body is accessible, and a closed position where access to the open interior of the enclosure body is blocked. In the closed position, the at least one blocking member may or may not sufficiently engage or contact the enclosure body in order for the objects stored therein to be shielded from external electromagnetic signals, e.g., RFID or NFC signals, electromagnetic interference (EMI) or radio frequency interference (RFI), and to limit electromagnetic signals, e.g., RFID or NFC signals, from exiting the open interior of the enclosure body. To improve the shielding at the junction between the enclosure body and the at least one blocking member is shielded, one or more shielding gaskets or shielding members may be attached to the at least one blocking member or the enclosure body at a point where the at least one blocking member meets the enclosure body when the at least one blocking member is in the closed position. In another embodiment, the one or more shielding gaskets or shielding members may be attached to the at least one blocking member and the enclosure body at a point where the at least one blocking member meets the enclosure body when the at least one blocking member is in the closed position. The one or more shielding gaskets or members are provided to ensure that any gap between the enclosure body and the at least one blocking member when the at least one blocking member is in the closed position does not reduce the shielding effectiveness of the enclosure.

It is noted that the present disclosure contemplates embodiments where the enclosure may also be made of non-conductive materials, but an outer surface of the enclosure body and the at least one blocking member are coating with an electrically conductive material, e.g., electrically conductive paints, electrically conductive epoxies, and electrically conductive silicones, in order to provide the desired electromagnetic shielding.

The enclosure body or the at least one blocking member may include a controller. In an exemplary embodiment, the controller includes a processor, a tag reader, e.g., an RFID or near field communication (NFC) reader, and communication circuitry. The enclosure body or at least one blocking member may also include a display, e.g., an LCD screen, which is controlled by the controller. The display can be used as an electronic label for the enclosure displaying identifying information and other information about the enclosure itself. The display may also display the inventory of objects stored within the enclosure.

In another exemplary embodiment, the smart enclosure may include an enclosure body having an open interior and a cover. The cover is secured to the enclosure body so that the cover is movable between an open position and a closed position. When the cover is in the closed position, the body and cover form a shield that limits electromagnetic signals, such as RFID or NFC signals, outside the enclosure from entering the enclosure, and limits electromagnetic signals, such as RFID or NFC signals, inside the enclosure from exiting the enclosure. The cover includes a controller having a processor, memory, a tag reader, e.g., an RFID or NFC reader, and network connectivity circuitry configured to communicate with one or more external network appliances. The controller also includes wireless communication circuitry so that the controller can communicate with, for example, mobile devices, e.g., a smartphone.

In another exemplary embodiment, the smart enclosure may include a body having an open interior and a blocking member, such as a door, cover or lid. The blocking member is secured to the body and movable between an open position and a closed position. When the blocking member is in the closed position, the blocking member blocks access to an open interior of the body. The blocking member or the body includes a controller adapted to read tags, e.g., RFID or NFC tags, store tag information read from the tags, e.g., the RFID or NFC tags, and to transmit the stored tag information to one or more devices external to the enclosure. In an exemplary embodiment, the controller includes a processor, memory, a tag reader, e.g., an RFID or NFC reader, and communication circuitry. It is noted that the blocking member or the body include a display in communication with the controller that is visible from an exterior of the enclosure. When the blocking member is in the closed position, the body and blocking member form a shield that limits electromagnetic signals outside the enclosure from entering the enclosure and that limits electromagnetic signals inside the enclosure from exiting the enclosure. In this configuration, electromagnetic signals, e.g., RFID or NFC signals, outside the enclosure do not enter the enclosure, and electromagnetic signals, e.g., RFID or NFC signals, inside the enclosure do not exit the enclosure. At least one shielding member may be positioned on the body, the blocking member or both the body and the blocking member so that when the blocking member is in the closed position the at least one shielding member is positioned at or within any gaps between the body and the blocking member. Providing the at least one shielding member limits electromagnetic signals, e.g., RFID or NFC signals, outside the enclosure from entering the enclosure through any gaps between the body and the at least one blocking member. Similarly, providing the at least one shielding member limits electromagnetic signals, e.g., RFID or NFC signals, inside the enclosure from exiting the enclosure through any gaps between the body and the at least one blocking member. The at least one shielding member may be a shielding gasket.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a perspective view of an exemplary embodiment of a smart enclosure according to the present disclosure, illustrating an enclosure body and an enclosure blocking member in a closed position;

FIG. 2 is a perspective view of the smart enclosure of FIG. 1, illustrating the enclosure blocking member in an open position revealing a shielding gasket around a perimeter of a top surface of the enclosure body;

FIG. 2A is an enlarged perspective view of a portion of the smart enclosure of FIG. 1 taken from detail 2A, illustrating the shielding gasket attached to the top surface of the enclosure body; and

FIG. 3 is a perspective view of another exemplary embodiment of a smart enclosure according to the present disclosure, illustrating a shielding gasket around a perimeter of a bottom surface of the enclosure blocking member.

### DETAILED DESCRIPTION

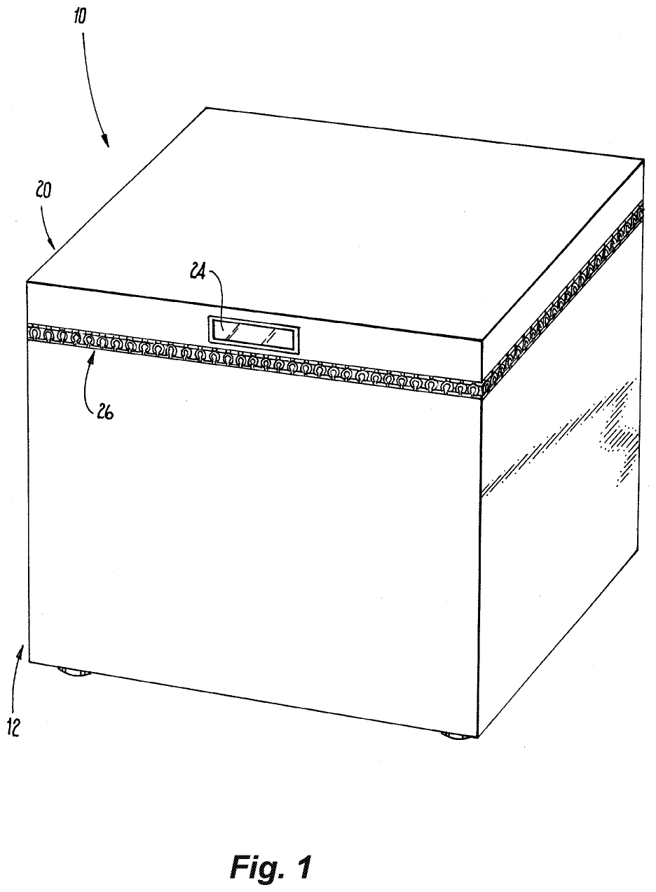

Referring to FIGS. 1-3, exemplary embodiments of the smart enclosure 10 according to the present disclosure is shown. The enclosure 10 includes a body 12 and an enclosure blocking member 20. The enclosure 10 may come in various shapes and sizes, such as a cube shape, a rectangular prism shape, or a cylindrical shape. As an example, the enclosure may be a 2′×2′×2′ enclosure. As another example, the enclosure may be a 2′×4′×2′ enclosure. The enclosure body 12 has an open interior 14 configured to store objects, such as datacenter equipment. As noted above, for datacenter uses, non-limiting examples of the objects contemplated by the present disclosure include fiber optic cables, fiber optic connectors, fiber optic adapters, tie wraps, power cords, modems and routers. Each object stored in the enclosure 10 has an associated tag, e.g., an RFID or NFC tag, which is typically on the packaging holding the object or objects. However, the present disclosure contemplates that the tags, e.g., the NFC tags or RFID tags, may be directly attached to the object or objects. For ease of description, the enclosure body 12 of the enclosure 10 may also be referred to herein as the “body” and the enclosure blocking member 20 of the enclosure 10 may also be referred to herein as the “blocking member.” In the exemplary embodiment shown, the blocking member 20 may be a cover or lid providing or blocking access to the open interior 14 of the enclosure body 12 from a top of the enclosure body 12. In another exemplary embodiment, the blocking member 20 may be door or other structure providing or blocking access to the open interior 14 of the enclosure body 12 from a side wall of the enclosure body 12. The blocking member 20 may be movably secured to the enclosure body 12 using for example one or more hinges.

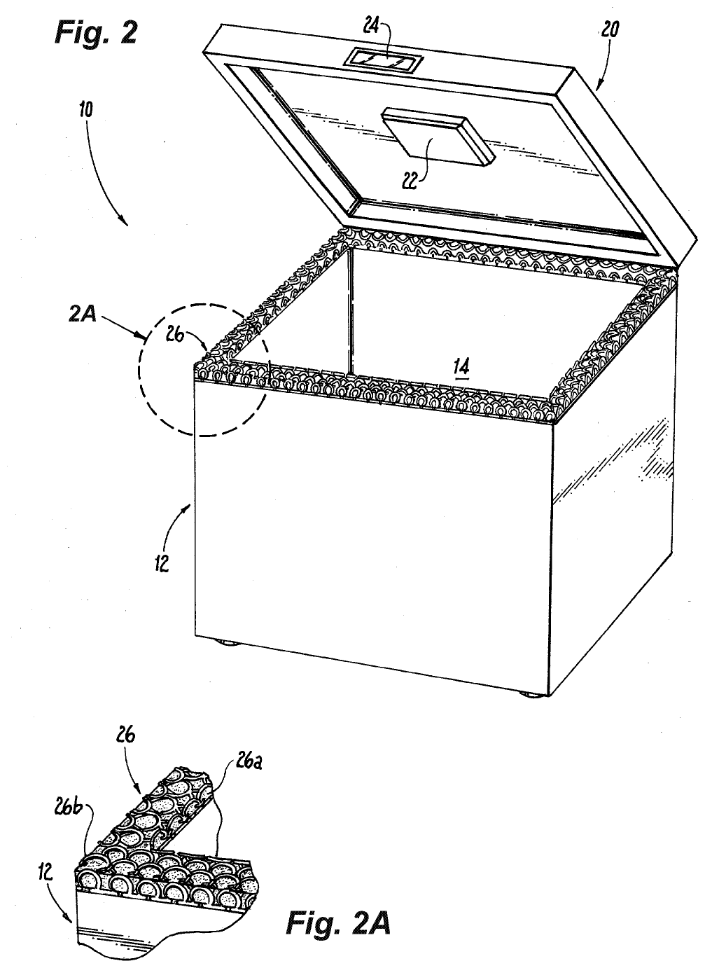

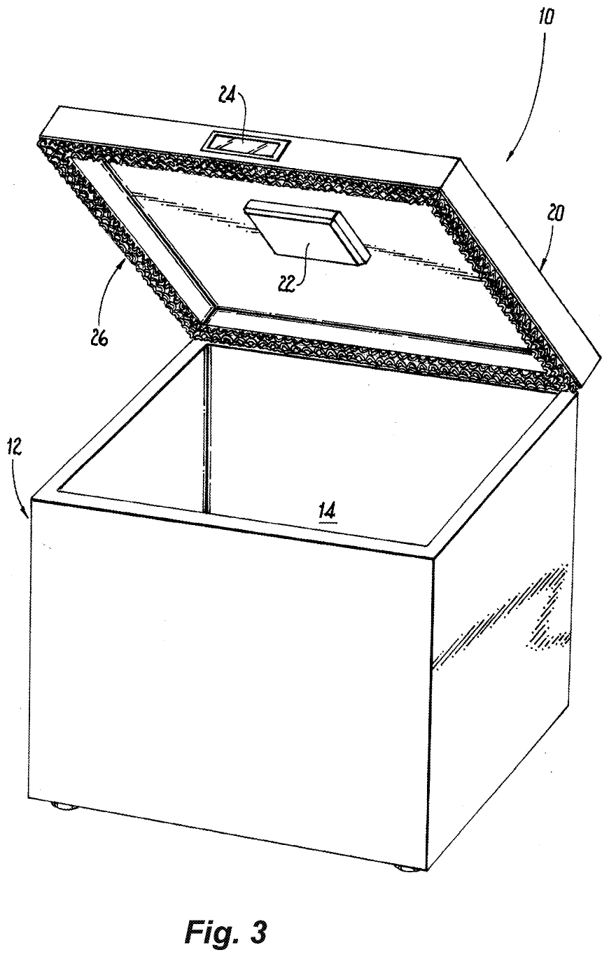

The enclosure 10 may include a controller 22 used to take an inventory of the objects within the enclosure 10 and to be able to communicate that inventory to remote computing devices, such as mobile phones, networked computing devices or a network based cloud computing environment. When communicating with a networked computing device or network based cloud computing environment that is managed by an orchestration system the inventory of the enclosures 10 can be provided to such orchestration system. A non-limiting example of an orchestration system if the AllPath® Director technology developed by Fiber Mountain, Inc. (Green Lambda Corporation), Norman, Oklahoma, which is incorporated herein in its entirety by reference. The controller 22 may be included within the enclosure body 12 or with the blocking member 20. In the exemplary embodiments shown in FIGS. 2 and 3, the blocking member 20 includes the controller 22 in an inside surface of the blocking member 20 such that when the blocking member 20 is in the closed position, the controller 22 can periodically perform an inventory operation to determine predefined characteristics of the object or objects within the enclosure body 12, or the controller 22 can be programmed to perform an inventory operation each time the blocking member 20 is moved to the closed position. Non-limiting examples of the determine predefined characteristics of the object or objects within the enclosure body 12 include, the type of object or objects stored within the enclosure body 12, the quantity of object or objects stored within the enclosure body, the size of the objects stored within the enclosure body, and the length of time the objects or objects have been stored within the enclosure body 12.

In an exemplary embodiment, the controller 22 includes a processor and associated memory, e.g., static and dynamic memory, a tag reader, e.g., an RFID or NFC tag reader, and communication circuitry. The processor may be a Raspberry Pi computer. For ease of description, the tag reader may also be referred to herein as the RFID reader. The RFID reader is provided to read the RFID tags attached to each package holding one or more objects and/or attached directly to each object within the enclosure 10 and store such information read from the RFID tags in the memory of the controller 22. The communication circuitry may include wireless or wired communications. Preferably, the communication circuitry includes wireless communication circuitry using for example, Bluetooth, Wi-Fi, WiMAX, ZigBee, cellular or other wireless communication technologies. To communicate outside with mobile devices, e.g., a mobile phone, or fixed devices, e.g., networked devices or cloud based computing environments, the enclosure 10 may have one or more antennas (not shown) positioned on the exterior of the enclosure 10. Power to the controller 22 may be derived from an AC source, Power over Ethernet (POE), or battery power.

The enclosure 10 may include a display 24 that is operatively connected to the controller 22 so that the display 24 is controlled by and interacts with the controller 22. Preferably, the display 24 is visible from an exterior of the enclosure 10. The display 24 may be an LCD display, however other known displays may be utilized. In the exemplary embodiment shown, the display 24 is positioned on the blocking member 20 so that the display 24 is visible from an exterior of the blocking member 20. The display 24 can be used as an electronic label for the enclosure identifying the particular enclosure 10, its location and other information about the enclosure 10 itself. The display 24 may also display information about the objects, e.g., the equipment, stored within the enclosure 10.

Continuing to refer to FIGS. 2, 2A and 3, the enclosure body 12 and blocking member 20 are constructed to shield electromagnetic signals outside the enclosure from entering the enclosure, and electromagnetic signals inside the enclosure from exiting the enclosure. The electromagnetic shielding may be in the form of a Faraday cage. Thus, the one or more walls forming the enclosure body 12 and the one or more walls forming the blocking member 20 may be made of a solid or meshed electrically conductive material, such as aluminum and/or copper material. The walls of the enclosure 10 may also be connected to electrical ground. As noted, the blocking member 20 is movable between an open position, seen in FIG. 2, where the open interior 14 of the enclosure body 12 is accessible, and a closed position, seen in FIG. 1, where access to the open interior 14 of the enclosure body 12 is blocked. As noted above, in the embodiment shown, the blocking member 20 is a cover. In the closed position, at least a portion of a bottom surface or edge of one or more walls of the cover 20 engages or contacts at least a portion of an upper surface or edge of the one or more walls of the enclosure body 12, but a gap may be present between the surfaces. In order to improve the electromagnetic shield, the gap between the upper surface or edge of the one or more walls of the enclosure body 12 and the bottom surface or edge of one or more walls of the cover 20 may also be electromagnetically shielded. To achieve this, one or more shielding gaskets 26 may be attached to the enclosure body 12 at a point where the enclosure body 12 meets the cover 20 when the cover 20 is in the closed position, as shown in FIG. 2. In another exemplary embodiment, one or more shielding gaskets 26 may be attached to the cover 20 at a point where the cover 20 meets the enclosure body 12 when the cover is in the closed position, as shown in FIG. 3. In another exemplary embodiment, one or more shielding gaskets 26 may be attached to the enclosure body 12 at a point where the enclosure body 12 meets the cover 20 when the cover 20 is in the closed position, and one or more shielding gaskets 26 may be attached to the cover 20 at a point where the cover 20 meets the enclosure body 12 when the cover 20 is in the closed position. The one or more shielding gaskets 26 are provided to ensure that the gap between the enclosure body 12 and the cover 20 when the cover 20 is in the closed position does not reduce shielding effectiveness of the enclosure 10. Referring to FIG. 2A, an exemplary embodiment of the shielding gasket or shielding member 26 according to the present disclosure is shown. In this exemplary embodiment, the shielding member 26 includes a flexible foam core 26a that is wrapped in a wire mesh or in knitted wire 26b. In other exemplary embodiments, the shielding member 26 may be a silicone or fluorosilicone member with an electrically conductive filler material or an electrically conductive sheet or strip along or around the silicone or fluorosilicone member. The present disclosure also contemplates other known shielding gaskets or member.

The enclosure 10 may also be a non-shielding enclosure, where the enclosure body 12 and blocking member 20 are formed of a non-conductive material and an electrically conductive coating is applied to the interior, exterior or both the interior and exterior of the one or more walls forming the enclosure body 12 and to the interior, exterior or both the interior and exterior of the one or more walls forming the blocking member 20. The electrically conductive coating provide the electromagnetic shielding for the enclosure 10. Non-limiting examples of the electrically conductive coating include electrically conductive paints and electrically conductive epoxies, and electrically conductive silicones, in order to provide the desired electromagnetic shielding.

### Operation

Each object that is stored in the enclosure 10 has an RFID tag attached thereto or attached to the packaging holding one or more objects. When the blocking member 20 is in the closed position, the RFID reader within the enclosure 10 and associated with the controller 22 reads the RFID tags within the enclosure 10, and stores information read from the RFID tags in the controller's memory. The controller 22 can then send the inventory information to a mobile device, such as a smartphone, or other computing device external to the enclosure 10. When the blocking member 20 is in the open position, the RFID reader of the controller 22 does not read the RFID tags on the objects within the enclosure. By having the enclosure shielded as described above, RFID readers that are outside the one or more enclosures at a location cannot determine what objects are stored in the one or more enclosures. Similarly, the RFID of the controller 22 cannot read RFID tags that are outside the enclosure 10.

### Use Case & Application

Potential use cases and applications for the enclosure 10 according to the present disclosure include:
Customer can identify where purchased objects, e.g., fiber optic cables are stored on an enclosure 10 by enclosure 10 basis.
Technicians can determine which enclosure 10 a particular object, e.g., fiber optic cable, is stored using an app running on a mobile device. For example, a technician using the mobile device app, can find the enclosure 10 where a 3 meter MPO to MPO cable is stored.
Each enclosure 10 has a unique ID and may include a time and location the enclosure 10 was installed. A non-limiting example of the unique ID for an enclosure 10 is UNIQUE #+Location/Site/Customer/ETC. ID
The enclosure 10 can be connected to a network and a software application in a network appliance can provide information on each enclosure 10 managed by the network appliance.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

What is claimed is:

1. A smart enclosure comprising:
a body having an open interior; and
a blocking member secured to the body and movable between an open position and a closed position, such that when blocking member is in the closed position the blocking member blocks access to an open interior of the body;
wherein the blocking member or body includes a controller adapted to read tags, store the read tag information and to transmit the stored tag information to one or more devices external to the enclosure; and
wherein when blocking member is in the closed position, the body and blocking member form a shield that limits electromagnetic signals outside the enclosure from entering the enclosure and electromagnetic signals inside the enclosure from exiting the enclosure.

2. The smart enclosure according to claim 1, further comprising at least one shielding member between the body and the blocking member when the blocking member is in the closed position.

3. The smart enclosure according to claim 2, wherein the at least one shielding member comprises a shielding gasket.

4. The smart enclosure according to claim 1, wherein the blocking member or the body further comprise a display in communication with the controller.

5. The smart enclosure according to claim 1, wherein the controller comprises a processor, tag reader and communication circuitry.

6. The smart enclosure according to claim 5, wherein the tag reader comprises an RFID or NFC tag reader.

7. The smart enclosure according to claim 1, wherein the blocking member comprises a cover or a door.

8. A smart enclosure comprising:
a body having an open interior; and
a blocking member secured to the body and movable relative to the body between an open position and a closed position, such that when blocking member is in the closed position the blocking member blocks access to an open interior of the body; and
at least one shielding member secured to the body or the blocking member, such that when blocking member is in the closed position, the body, blocking member and at least one shielding member limits electromagnetic signals outside the enclosure from entering the enclosure and electromagnetic signals inside the enclosure from exiting the enclosure; and
wherein the blocking member or body includes a controller adapted to read tags, store read tag information and to transmit the stored tag information to one or more devices external to the enclosure.

9. The smart enclosure according to claim 8, wherein the blocking member or the body further comprise a display in communication with the controller.

10. The smart enclosure according to claim 8, wherein the controller comprises a processor, a tag reader and communication circuitry.

11. The smart enclosure according to claim 10, wherein the tag reader comprises an RFID or NFC tag reader.

12. The smart enclosure according to claim 8, wherein the at least one blocking member comprises a cover or a door.

13. The smart enclosure according to claim 8, wherein the at least one shielding member comprises a shielding gasket.

14. A smart enclosure comprising:
a body having an open interior; and
a cover secured to the body and movable relative to the body between an open position and a closed position;
wherein the cover includes a controller adapted to read tags, store read tag information and to transmit the stored tag information to one or more devices external to the enclosure; and
wherein when cover is in a closed position, the body and cover form a shield that limits electromagnetic signals outside the enclosure from entering the enclosure and electromagnetic signals inside the enclosure from exiting the enclosure.

15. The smart enclosure according to claim 14, further comprising at least one shielding member between the body and the cover when the cover is in the closed position.

16. The smart enclosure according to claim 15, wherein the at least one shielding member comprises a shielding gasket.

17. The smart enclosure according to claim 14, wherein the cover or the body further comprises a display in communication with the controller.

18. The smart enclosure according to claim 14, wherein the controller comprises a processor, a tag reader and communication circuitry.

19. The smart enclosure according to claim 18, wherein the tag reader comprises an RFID or NFC tag reader.
